(19) United States
(12) Patent Application Publication
(10) Pub. No.: US 2003/0028392 A1
(43) Pub. Date: Feb. 6, 2003

(54) Inventory control and pricing method and apparatus

(76) Inventor: David J. Davies, Noblesville, IN (US)

Correspondence Address: Marshall E. Rosenberg, The Gilbert Law Building, 22130 Clarendon Street, Woodland Hills, CA, 91367, US

(21) Appl. No.: 09/922,593

(22) Filed: Aug. 3, 2001

(51) Int. Cl. G06F 17/60

(52) U.S. Cl. 705/1; 705/400; 705/28

(57) ABSTRACT

A purchase item and inventorying system for garage sales is disclosed. The system includes a set of pricing labels for affixing pricing information including a monetary value denomination to articles available for sale, all of the pricing labels being individually removably affixed to a backing board. During use, remaining pricing labels are instantaneously viewable for determining inventory and aggregate pricing value of articles available for sale or sold. Each set of pricing labels is uniquely color coded for use by an assigned entity, group or family participating in the garage sale.

### BACKGROUND OF THE INVENTION

1. Field of the Invention

The present invention relates generally to pricing and inventory control systems, and more particularly to a pricing label and method for a price labeling and inventory control system for an identified universe of vendors at garage sales and the like.

### Background of the Invention

Pricing systems using labels, tags and the like are well known in the retail industry for price tagging articles for sale, by presenting pricing information to the prospective purchaser on or attached to the article. In many retail environments, such price tagging systems are interactively correlated with computerized stock and inventory systems for maintaining running inventory and associated sales reports. Such systems input article specifications, inventory location, prior historical sales reports and other pertinent sales information to track inventory down to the individual article level, assist in accounting tasks, and updating marketing systems to refresh the inventory stock.

However, in the thriving garage sale industry, such systems are not available due to the ad hoc nature of that type of sales environment typically operating without benefit of formal inventory and accounting systems. Nevertheless, vendors of articles for sale in the typically casual and unstructured environments in which most garage sales, flea markets, multi-family household sales, yard sales, and rummage sales, among others, operate still require some method and system for maintaining control over inventory and pricing. Heretofore, no such method or system is known to completely and satisfactorily address these specialized needs. That is, no prior art method or system is known to provide for a self-contained readily usable pricing and inventorying system which enables easy access to price labels while maintaining instantaneous pricing and inventory control outside of a regular commercial retail environment with their established inventorying and pricing systems.

Accordingly, there is a need to provide a readily and easily useable pricing and inventorying system for relatively low-volume garage sales and the like, which is capable of pricing items at preselected or customized price points while enabling immediate determinations of pricing and remaining inventory during and after the sales activity.

It is thus an object of the present invention to solve this long-felt but unsolved need for a simple but flexible system for price tagging articles while providing an inventorying system which provides immediate purchase and inventory information to the vendor.

### SUMMARY OF THE INVENTION

The present invention is a method, system and kit for pricing and inventorying articles for sale at garage sales, tag sales, flea markets, and the like. The invention includes a set of pricing labels for affixing pricing information including a monetary value denomination to articles available for sale, all of the pricing labels being individually removably affixed to a backing board. For multi-entity/multi-family use, each entity/family is assigned a price tag kit that is uniquely color coded with a family color different from the color coded kits assigned to any other on-site entity/family. During use, pricing labels are instantaneously viewable for determining inventory and aggregate pricing value of articles available for sale or sold.

Each pricing label may be optionally denominated with a custom monetary value, and each set of pricing labels has an aggregate monetary value. Each pricing label set is color coded with at least one color selected from the group of colors including red, blue, yellow, green, black, white, pink, tan, and gray, although other colors and families of colors may be used with the present invention. Each pricing label is preferably self-adhesive for ready application to an article to price tagged.

According to another embodiment of the invention, the pricing labels may include a plurality of labels preprinted with scrip value, for redemption in other than legal tender such as the U.S. dollar and fractions and multiples thereof. When used in conjunction with the U.S. currency system, monetary designations may be selected from the group including $0.10, 0.25, 0.50, 0.75, 1.00, 2.00, 3.00, 4.00, 5.00, and 10.00, among others.

### BRIEF DESCRIPTION OF THE DRAWINGS

FIG. 1 is a front planar view of a set of pricing labels removably affixed to a backing board according to a first embodiment of the purchase item and inventorying system of the present invention, further showing one pricing label partially affixed to the backing board.

FIG. 2 is a table of the quantity of pricing labels carrying the denominated article value, provided per kit of pricing labels.

FIG. 3 is a front planar view of a plurality of sets of pricing labels removably affixed to a like number of backing boards, for use in a group sales environment such as a multi-family garage sale, each set of pricing labels being uniquely color coded according to the present invention.

FIG. 4 is a block diagram representation of the method of use of the purchase item and inventorying system of the present invention.

### DETAILED DESCRIPTION

With reference now to the drawings, according to one embodiment of the present invention, FIG. 1 shows a system 10 as it is implemented in a pricing and inventorying system according to any embodiment of the present invention. System 10 includes a backing board 12 having a top planar surface 14 for supporting a plurality of pricing labels 16. More specifically, backing board 12 may be a planar or laminate type structure, with a rigid or flexible bending characteristic, compatible with adhesive-backed pricing labels 16. The backing board may be compatible with either single-usage or reusable pricing labels 16. Alternatively, and as will be apparent to the skilled artisan, the backing board may integrated with or affixed to a separate structure for packaging or marketing purposes. Materials of construction may include cardboard, vinyl or plastic coated cardboard or card stock, plastics, metals, or other materials either as necessary only to secure the pricing labels 16 or as may be incorporated in a larger package as described above. Any backing board 12 or equivalent thereto will provide a sufficient planar surface on which to adhere pricing labels 16 to achieve the objectives of the present invention.

Pricing labels 16 for pricing tagging articles such as article 50 (FIG. 1a) are provided in color coded sets, the use of which will be further described below. Color coding includes one color, or possibly a combination of colors, selected from the group including red, blue, yellow, green, black, white, pink, tan and gray. When used in combination, complementary colors may be striped, bordered or otherwise included on the pricing label to distinguish one set of labels 16 from another. Single or combination color combinations may be used not only to identify a single entity or family during usage, but also to optionally identify other features including subject matter, price class, value or appraisal grade, or other distinguishing product or family characteristics. Each pricing label 16 is preferably self-adhesive for ready application to an article to price tagged. For example, each pricing label 16 may be coated on the underside 17 thereof with a pressure sensitive adhesive 19 on a portion thereof. During packaging of the system 10, individual pricing labels 16 may be provided with a release paper backing which prevents the adhesive from sticking to other surfaces prior to first use. Alternatively, some or all of the pricing labels 16 may be affixed to the backing board 12 for immediate removal and affixation to an article 50.

Each of the pricing labels 16 is inscribed, printed, embossed or otherwise designated with monetary value information, such as that associated with legal currency or in proprietary scrip. Again with reference to FIG. 1, such monetary values include pricing labels 16 in the amount of US$0.10, pricing labels 18 in the amount of $0.25, pricing labels 20 in the amount of $0.50, pricing labels 22 in the amount of $0.75, pricing labels 24 in the amount of $1.00, pricing labels 26 in the amount of $2.00, pricing labels 28 in the amount of $3.00, pricing labels 30 in the amount of $4.00, pricing labels 32 in the amount of $5.00, and pricing labels 34 in the amount of $10.00. Because some articles, even in the garage sale context, may be priced even higher, various combinations of pricing labels 16-34 may be used to price tag the article, and pricing thereof may be provided on blank pricing labels 36.

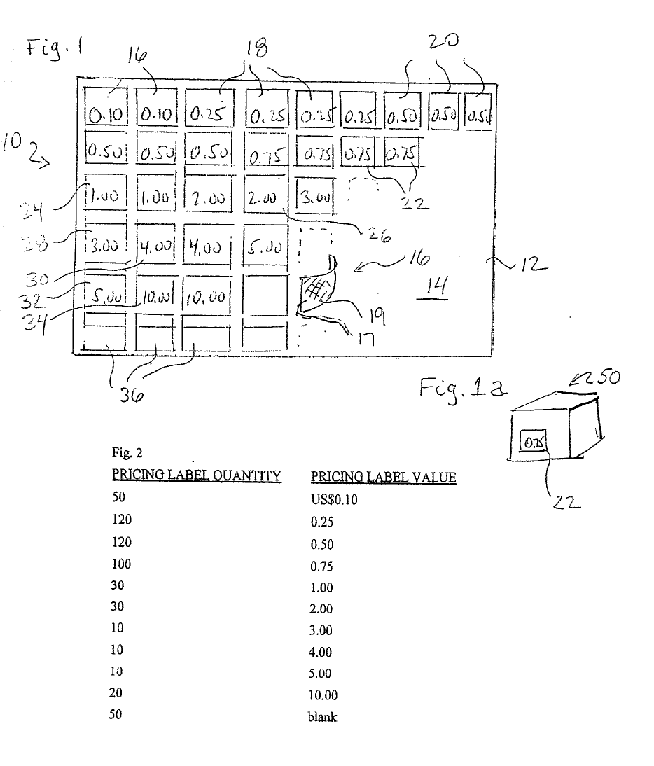

In the aggregate, however, and with reference to FIG. 2 and according to one embodiment of the invention, a predetermined number of pricing labels of predetermined value each has a predetermined aggregate value. According to this embodiment, a total of 500 labels are provided with an aggregate amount of $580.00. According to the invention, the pricing labels may be denominated with other values as necessary and desirable to accommodate a market place with higher or lower selling prices. The additional blank labels 36 may be denominated as necessary, the aggregate value of which should be determined prior to use of the system 10 so that a total aggregate value will be available from which subsequent pricing and inventorying calculations may be determined.

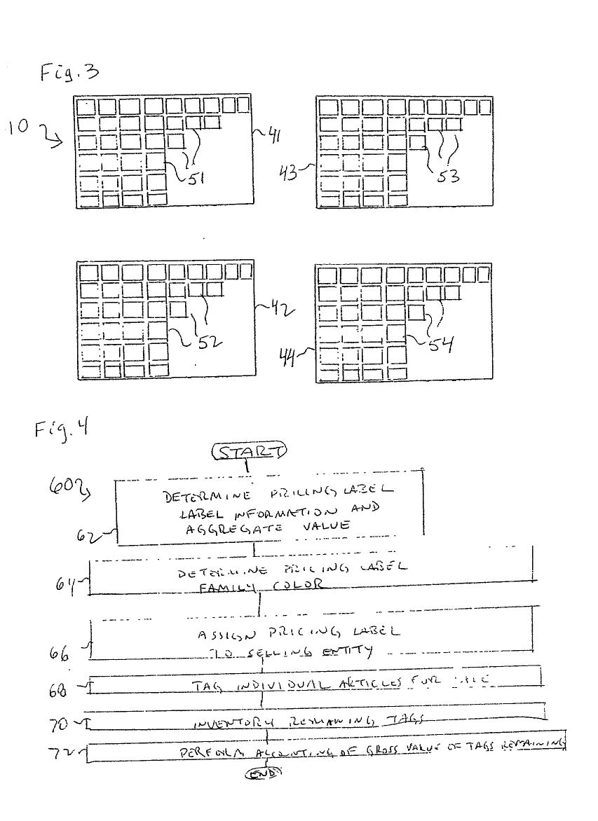

Referring now to FIG. 3, a system 40 is shown in which a plurality of systems 41, 42, 43, 44 similar to individual use-system 10 may be used in a closed or open selling environment such as a multi-family tag sale. It will be understood that any number of systems may be in contemporaneous use, as long as no two systems share the same color coding scheme. According to this embodiment, each system 41, 42, 43, 44 is uniquely color coded in the manner described above to avoid confusion therebetween, although structured monetary values 51, 52, 53, 54 may be the same or different depending on the nature of the articles available for sale. For example, a typical family tag sale may include 10 families, each of which would be assigned a system 40 being color coded differently from any other system 40. It is further contemplated that any of the systems 10, 40 may be packaged for individual sale, or for group sales in groups of two, five, 10, 20 or other number of entities/families to be represented in the marketplace. Such packaging may also optionally provide signage indicating the nature of the sale, such as tag sale, rummage sale, or garage sale, with corresponding placards, banners, and the like.

In use, and with reference to FIG. 4, process flowchart 60 outlines the method of the present invention. Initially, pricing label information is determined for the articles being put up for sale, as well as determination of the aggregate value of the pricing labels available for affixation to backing board 12 (step 62). Step 64 requires selection of color coding of each entity/family participating in the marketplace. Step 66 requires assignment of the pricing label to the selling entity, and step 68 directs tagging of individual articles for sale with the appropriate pricing tags 16-36, 51-54. During and after the sales activity, a running or closing inventory analysis may be performed by evaluating the pricing labels remaining on the backing board 12 (step 70). Finally, an accounting performed during or after the sales activity is performed, by calculating the value of the pricing labels remaining on the backing board 12 in view of the aggregate value of the pricing labels determined in step 62 (step 72).

Also in accordance with the invention, replacement sets of pricing labels are made available and marketed separately from the kit as replacement labels for use with the system, kit and method of the present invention. Specifically, the replacement labels are made available for sale either by specific denomination to replenish depleted supplies of labels of specific denomination, or as subsets of specific denominations as will be appreciated by the skilled artisan, while preserving the distribution ratios (by entity, color, and denomination/value) as previously described.

These and other advantages of the invention will be better understood when the detailed description of the preferred embodiments of the invention is read in conjunction with the drawings.

1. A purchase item and inventorying system, comprising:
a set of pricing labels for removably affixing pricing information on articles being sold, the set of pricing labels including an array of pricing labels all of which are individually removably affixed to a backing board for instantaneous viewing and inventorying remaining labels and aggregate pricing value after selected labels have been removed therefrom;
each pricing label being color coded and having a monetary value denomination.

2. The system of claim 1, further comprising a plurality of sets of pricing labels each set dedicated for use by an assigned entity, wherein for use by plural entities, each pricing label set is differently color coded.

3. The system of claim 1, wherein each pricing label may be optionally denominated with a custom monetary value, and each set of pricing labels has an aggregate monetary value.

4. The system of claim 1, wherein each pricing label set is color coded with at least one color selected from the group of colors including red, blue, yellow, green, black, white, pink, tan, and gray.

5. The system of claim 1, wherein each pricing label set includes a plurality of labels preprinted with scrip value.

6. The system of claim 4, wherein the labels include monetary designations for one U.S. dollar and fractions and multiples thereof.

7. The system of claim 6, wherein the monetary designations are selected from the group including $0.10, 0.25, 0.50, 0.75, 1.00, 2.00, 3.00, 4.00, 5.00, and 10.00.

8. A kit for pricing and inventorying a plurality of articles to be sold by a plurality of entities, comprising:
a backing board; and
a plurality of sets of pricing labels, each set color coded and inscribed with monetary value information, all of said pricing labels being individually removably affixed to the backing board for instantaneous viewing and inventorying remaining labels and aggregate pricing value after selected labels have been removed therefrom.

9. The kit of claim 8, wherein each pricing label may be optionally denominated with a custom monetary value, and each set of pricing labels has an aggregate monetary value.

10. The system of claim 8, wherein each pricing label set is color coded with at least one color selected from the group of colors including red, blue, yellow, green, black, white, pink, tan, and gray.

11. The system of claim 8, wherein each pricing label set includes a plurality of labels preprinted with scrip value.

12. The system of claim 8, wherein the labels include monetary designations for one U.S. dollar and fractions and multiples thereof.

13. The system of claim 12, wherein the monetary designations are selected from the group including $0.10, 0.25, 0.50, 0.75, 1.00, 2.00, 3.00, 4.00, 5.00, and 10.00.

14. A method for price tagging and inventorying a plurality of articles to be sold in a market place, comprising:
assigning a set of pricing labels mounted to a backing board to an entity, the set of pricing labels being commonly color coded and each pricing label of the set of pricing labels including a preselected price, the set of pricing labels having a preselected aggregate monetary value;
selecting and affixing a pricing label to each article being sold by the entity;
inventorying the articles to be sold by color coding; and
accounting for gross proceeds by subtracting the aggregate value of pricing labels remaining on the backing board from the preselected aggregate monetary value.

15. The method of claim 14, further comprising:
assigning an additional commonly color coded set of pricing labels to each additional entity competing in the market place, each additional color coded set having a color coding different from any other color coded set assigned to any other entity.

16. The method of claim 14, further comprising:
assigning a common color coding to the color coded set of pricing labels selected from the group of colors including red, blue, yellow, green, black, white, pink, tan, and gray.

17. The method of claim 14, further comprising:
assigning to each pricing label a monetary designation having currency or scrip value.

18. The method of claim 17, wherein the monetary designations are selected from the group including US$0.10, 0.25, 0.50, 0.75, 1.00, 2.00, 3.00, 4.00, and 5.00.

19. Garage sale pricing labels for removably affixing price information to articles for sale by a plurality of entities in a market place, comprising:
a set of uniquely color coded pricing labels assigned to each entity, each set of pricing labels having a monetary value denomination and being individually removably affixed to a backing board, the aggregate monetary value of each set of pricing labels having a preselected value.

20. The garage sale pricing labels of claim 19, wherein individual labels are denominated by pattern, shape or size.

21. The garage sale pricing labels of claim 19, wherein each set of pricing labels affixed to the backing board are readily viewable for inventorying remaining labels and aggregate pricing value after selected labels have been removed therefrom.
